(19) United States
(12) Patent Application Publication
(10) Pub. No.: US 2021/0234630 A1
(43) Pub. Date: Jul. 29, 2021

(54) MCS TABLE DETERMINATION METHOD, TERMINAL, AND BASE STATION AND READABLE STORAGE MEDIUM

(71) Applicant: DATANG MOBILE COMMUNICATIONS EQUIPMENT CO., LTD., Beijing (CN)

(72) Inventors: Wei BAI, Beijing (CN); Yanping XING, Beijing (CN); Xuejuan GAO, Beijing (CN)

(21) Appl. No.: 17/053,358

(22) PCT Filed: May 5, 2019
(86) PCT No.: PCT/CN2019/085575

§ 371 Date: Nov. 6, 2020

(30) Foreign Application Priority Data
May 11, 2018 (CN) 201810449340.0

(51) Int. Cl. H04L 1/00; H04L 5/00

(52) U.S. Cl. CPC H04L 1/0009; H04L 5/0053; H04L 1/0003

(57) ABSTRACT

An MCS table determination method, terminal, and base station and readable storage medium, used to determine an MCS table to be used in a communication process from out of a plurality of MCS tables. The method comprises: a terminal receives radio resource control (RRC) signaling sent by a base station and carrying indication information, the indication information being used to indicate a first MCS table, the first MCS table being one of a first MCS table type and a second MCS table type; and the terminal determines the first MCS table on the basis of the indication information.

The present application is a National Stage of International Application No. PCT/CN2019/085575 filed May 5, 2019, which claims priority to the Chinese Patent

Application filed with the Chinese Patent Office on May 11, 2018 with the No. 201810449340.0 and entitled “MCS TABLE DETERMINATION METHOD, TERMINAL, AND BASE STATION AND READABLE STORAGE MEDIUM”, the entire contents of which are incorporated herein by reference.

### FIELD

The present disclosure relates to the field of computers, and in particular to a method for determining an MCS table, terminal, base station and readable storage medium.

### BACKGROUND

At present, with the development of mobile communication service requirements, in a 5 Generation New RAT (5G NR) system, a new transmission scheme is provided on the basis of communication requirements for low latency and high reliability, i.e., ultra-reliable low latency connection (URLLC) service. A corresponding modulation and coding scheme (MCS) table is newly defined for the URLLC service, then the 5G NR system includes more MCS tables, including MCS tables corresponding to 64-phase quadrature amplitude modulation (QAM), 256 QAM, and a bler (block error rate)-Target of 10⁻⁵, and possibly the MCS tables corresponding to the bler-Target of 10⁻¹ or other values.

For a terminal, enhanced Mobile Broadband (eMBB) service and URLLC service may be supported at the same time, and URLLC service may also correspond to the plurality of different bler-Targets, e.g., for the URLLC service, the bler-Target at initial transmission may be 10⁻¹, while the bler-Target at retransmission may be 10⁻⁵. At present, for eMBB, radio resource control (RRC) signaling includes an information element (IE) used to indicate the MCS tables, namely the modulation and coding scheme table (mcs-Table) which takes one bit, that is, two MCS table types may be indicated corresponding to the two MCS table types of eMBB, namely 64 QAM and 256 QAM. However, the MCS table defined for URLLC cannot be indicated at present, so that the terminal cannot determine the currently used MCS table, and thus a communication process cannot be accurately carried out, and user experience is not good.

### SUMMARY

Embodiments of the present disclosure provides a method for determining an MCS table, terminal, base station and readable storage medium, used to determine an MCS table to be used in a communication process from a plurality of MCS tables.

In one embodiment, provided is a method for determining an MCS table, including:

receiving radio resource control (RRC) signaling carrying indication information and sent by a base station through a terminal, and the indication information indicates a first MCS table, and the first MCS table is one of a first type of MCS tables and a second type of MCS tables; and determining the first MCS table by the terminal based on the indication information.

In the method, the first MCS table indicated by the indication information can be one of a first type of MCS tables and a second type of MCS tables, that is, the indication information may indicate a plurality of MCS table types, such as an MCS table corresponding to eMBB and an MCS table corresponding to URLLC, so that the terminal can correctly determine the MCS table used by current service, and thus correct proceeding of a communication process is ensured, and the quality of user communication experience is enhanced.

In one embodiment, when the indication information is a channel quality indicator table (cqi-Table), the determining the first MCS table by the terminal based on the indication information includes: determining the first MCS table corresponding to a value of the cqi-Table by the terminal based on the value of the cqi-Table, where different values of the cqi-Table indicate different MCS tables, and one value corresponds to one MCS table.

In the method, the MCS table can be implicitly indicated through the cqi-Table, so that on the basis of ensuring that the terminal correctly determines the MCS table, new definition of a field in the RRC signaling can also be avoided, and thus the method is more convenient.

In one embodiment, the determining the first MCS table by the terminal based on the indication information includes: determining the type of the first MCS table by the terminal based on the indication information; determining the first MCS table from the first type of MCS tables by the terminal based on an mcs-Table carried by the indication information, under the condition that the first MCS table is determined to be the first type of MCS tables, where the value of the mcs-Table is in one-to-one correspondence with each MCS table in the first type of MCS tables; or determining the first MCS table from the second type of MCS tables by the terminal based on an mcs-Table carried by the indication information, under the condition that the first MCS table is determined to be the second type of MCS tables, where the value of the mcs-Table is in one-to-one correspondence with each MCS table in the second type of MCS tables.

According to the method, more MCS tables can be indicated through the current mcs-Table by distinguishing the different MCS table types, so that on the basis of ensuring that the terminal correctly determines the MCS table, new definition of the field in the RRC signaling can also be avoided, and thus the method is more convenient.

In one embodiment, the determining the type of the first MCS table by the terminal based on the indication information includes: determining whether the indication information carries a bler-Target by the terminal; and determining the first MCS table to be the first type of MCS tables by the terminal, in response to that the terminal determines that the indication information does not carry the bler-Target; or determining the first MCS table to be the second type of MCS tables by the terminal in response to that the indication information carries the bler-Target.

In one embodiment, the determining the type of the first MCS table by the terminal based on the indication information includes: determining that the first MCS table is the second type of MCS tables, when the terminal determines that the bler-Target carried by the indication information is a first value; or determining the type of the first MCS table based on the value of the cqi-Table carried by the indication information, when the terminal determines that the bler-Target carried by the indication information is a second value.

In one embodiment, the determining the first MCS table by the terminal based on the indication information includes: determining the first MCS table from the second type of MCS tables by the terminal based on the value of a new-mcs-Table, when the terminal determines that the indication information carries a newly defined new-mcs-Table configured to indicate the second type of MCS tables, where the value of the new-mcs-Table is in one-to-one correspondence with each MCS table in the second type of MCS tables; or determining the first MCS table from the first type of MCS tables by the terminal based on the value of the mcs-Table carried by the indication information, when the terminal determines that the indication information does not carry the new-mcs-Table, where the value of the mcs-Table is in one-to-one correspondence with each MCS table in the first type of MCS tables.

According to the method, the field used to indicate the second type of MCS tables is newly defined, so that an indication method is provided for the newly added MCS table, and thus the condition that the terminal can correctly determine the MCS table is ensured.

In one embodiment, the determining the first MCS table by the terminal based on the indication information includes: determining the type of the first MCS table by the terminal based on a service Table carried by the indication information, and the service-Table is the newly defined field configured to indicate the type of the MCS table, and the service-Table includes at least one bit; and determining the first MCS table from the second type of MCS tables by the terminal based on the value of the new-mcs-Table carried by the indication information, when the terminal determines that the first MCS table is the second type of MCS tables, where the value of the new-mcs-Table is in one-to-one correspondence with each MCS table in the second type of MCS tables; or determining the first MCS table from the first type of MCS tables by the terminal based on the value of the mcs-Table carried by the indication information, when the terminal determines that the first MCS table is the first type of MCS tables, where the value of the mcs-Table is in one-to-one correspondence with each MCS table in the first type of MCS tables.

In one embodiment, the determining the first MCS table based on the indication information by the terminal includes: determining the type of the first MCS table by the terminal based on the service-Table carried by the indication information, where the service-Table is the newly defined field configured to indicate the type of the MCS table, and the service-Table includes at least one bit; and determining the first MCS table from the second type of MCS tables by the terminal based on the value of the mcs-Table carried by the indication information, when the terminal determines that the first MCS table is the second type of MCS tables, where the value of the mcs-Table is in one-to-one correspondence with each MCS table in the second type of MCS tables; or determining the first MCS table from the first type of MCS tables by the terminal based on the value of the mcs-Table carried by the indication information, when the terminal determines that the first MCS table is the first type of MCS tables, where the value of the mcs-Table is in one-to-one correspondence with each MCS table in the first type of MCS tables.

In one embodiment, the determining the first MCS table based on the indication information by the terminal includes: determining the type of the first MCS table by the terminal based on the service-Table carried by the indication information, where the service-Table is a newly defined field configured to indicate the type of the MCS table, and the service-Table includes at least one bit; and determining that the first MCS table is the MCS table included in the second type of MCS tables by the terminal, when the terminal determines that the first MCS table is the second type of MCS tables, and the second type of MCS tables only include one MCS table.

In one embodiment, when the indication information is the mcs-Table, the determining the first MCS table based on the indication information by the terminal includes: determining the first MCS table corresponding to the value of the mcs-Table by the terminal based on the value of the mcs-Table, and the mcs-Table includes at least two bits, different values of the mcs-Table are configured to indicate different MCS tables, and one value corresponds to one MCS table.

In one embodiment, the first type of MCS tables includes 64 QAM and 256 QAM; and the second type of MCS tables includes at least the MCS table corresponding to a bler-Target of 10⁻⁵.

In one embodiment, provided is an MCS table determination method, including: sending, by a base station, RRC signaling carrying indication information to a terminal, to enable the terminal to determine a first MCS table based on the indication information, where the indication information indicates the first MCS table, and the first MCS table is one of a first type of MCS tables and a second type of MCS tables.

In one embodiment, the indication information is a cqi-Table, where the different values of the cqi-Table indicate the different MCS tables, and one value corresponds to one MCS table.

In one embodiment, the indication information carries an mcs-Table; when the first MCS table is the first type of MCS tables, the value of the mcs-Table is in one-to-one correspondence with each MCS table in the first type of MCS tables; or when the first MCS table is the second type of MCS tables, the value of the mcs-Table is in one-to-one correspondence with each MCS table in the second type of MCS tables.

In one embodiment, before the base station sends the RRC signaling carrying the indication information to the terminal, the method further includes: determining, by the base station, the type of the first MCS table; and determining that a bler-Target does not need to be carried in the indication information by the base station, when the base station determines that the first MCS table is the first type of MCS tables; or determining that the bler-Target needs to be carried in the indication information by the base station, when the base station determines that the first MCS table is the second type of MCS tables.

In one embodiment, when the bler-Target carried by the indication information is the first value, the bler-Target is configured to indicate that the first MCS table is the second type of MCS tables; or when a bler-Target carried by the indication information is the second value, the bler-Target is configured to indicate that the first MCS table is the second type of MCS tables, where the first value and the second value are configured to indicate different MCS tables included in the second type of MCS tables, respectively; or when a bler-Target carried by the indication information is the second value, the bler-Target is configured to indicate that the first MCS table is the first type of MCS tables.

In one embodiment, before the base station sends the RRC signaling carrying the indication information to the terminal, the method further includes: determining, by the base station, the type of the first MCS table; and determining that a newly defined new-mcs-Table used to indicate the second type of MCS tables needs to be carried in the indication information by the base station, when the base station determines that the first MCS table is the second type of MCS tables, where the value of the new-mcs-Table is in one-to-one correspondence with each MCS table in the second type of MCS tables; or determining that the new-mcs-Table does not need to be carried in the indication information by the base station, when the base station determines that the first MCS table is the first type of MCS tables.

In one embodiment, the indication information includes a service-Table, where the service-Table is the newly defined field configured to indicate the type of the MCS table, and the service-Table includes at least one bit; and when the type indicated by the service-Table is the second type of MCS tables, the indication information carries the new-mcs-Table, and the value of the new-mcs-Table is in one-to-one correspondence with each MCS table in the second type of MCS tables; or when the type indicated by the service-Table is the first type of MCS tables, the indication information does not carry the new-mcs-Table, and the value of the mcs-Table carried by the indication information is in one-to-one correspondence with each MCS table in the first type of MCS tables.

In one embodiment, the indication information includes the service-Table, where the service-Table is the newly defined field configured to indicate the type of the MCS table, and the service-Table includes at least one bit; and when the type indicated by the service-Table is the second type of MCS tables, the value of the mcs-Table carried by the indication information is in one-to-one correspondence with each MCS table in the second type of MCS tables; or when the type indicated by the service-Table is the first type of MCS tables, the value of the mcs-Table is in one-to-one correspondence with each MCS table in the first type of MCS tables.

In one embodiment, the indication information includes the service-Table, where the service-Table is a newly defined field configured to indicate the type of the MCS table, and the service-Table includes at least one bit; and when the type indicated by the service-Table is the second type of MCS tables, and the second type of MCS tables only include one MCS table, the first MCS table is the MCS table included in the second type of MCS tables.

In one embodiment, the indication information is an mcs-Table, where the mcs-Table includes at least two bits, different values of the mcs-Table are configured to indicate different MCS tables, and one value corresponds to one MCS table.

In one embodiment, the first type of MCS tables includes 64 QAM and 256 QAM; and the second type of MCS tables includes at least the MCS table corresponding to the bler-Target of 10⁻⁵.

In one embodiment, provided is a terminal that includes: a memory, configured to store instructions; a processor, configured to read the instructions in the memory to execute the following processes: receiving radio resource control (RRC) signaling carrying indication information and sent by a base station through a transceiver, where the indication information indicates a first MCS table, and the first MCS table is one of a first type of MCS tables and a second type of MCS tables; and determining the first MCS table based on the indication information; and the transceiver, configured to receive and send data under the control of the processor.

In one embodiment, when the indication information is a cqi-Table, the processor is further configured to: determine the first MCS table corresponding to the value of the cqi-Table based on the value of the cqi-Table, where different values of the cqi-Table indicate different MCS tables, and one value corresponds to one MCS table.

In one embodiment, the processor is further configured to: determine the type of the first MCS table based on the indication information; and determine the first MCS table from the first type of MCS tables based on an mcs-Table carried by the indication information, when the first MCS table is determined to be the first type of MCS tables, where the value of the mcs-Table is in one-to-one correspondence with each MCS table in the first type of MCS tables; or determine the first MCS table from the second type of MCS tables based on the mcs-Table carried by the indication information, when the first MCS table is determined to be the second type of MCS tables, where the value of the mcs-Table is in one-to-one correspondence with each MCS table in the second type of MCS tables.

In one embodiment, the processor is further configured to: determine whether the indication information carries a bler-Target; and determine the first MCS table to be the first type of MCS tables, in response to determining that the indication information does not carry the bler-Target; or determine the first MCS table to be the second type of MCS tables in response to that the indication information carries the bler-Target.

In one embodiment, the processor is further configured to: determine the first MCS table to be the second type of MCS tables, when the bler-Target carried by the indication information is determined to be a first value; or determine the type of the first MCS table based on the value of the cqi-Table carried by the indication information, when the bler-Target carried by the indication information is determined to be a second value.

In one embodiment, the processor is further configured to: determine the first MCS table from the second type of MCS tables based on the value of a new-MCS-Table, when it is determined that the indication information carries a newly defined new-mcs-Table configured to indicate the second type of MCS tables, where the value of the new-mcs-Table is in one-to-one correspondence with each MCS table in the second type of MCS tables; or determine the first MCS table from the first type of MCS tables on the basis of the value of the mcs-Table carried by the indication information, when it is determined that the indication information does not carry the new-mcs-Table, where the value of the mcs-Table is in one-to-one correspondence with each MCS table in the first type of MCS tables.

In one embodiment, the processor is configured to: determine a type of the first MCS table based on a service-Table carried by the indication information, where the service-Table is a newly defined field configured to indicate the type of the MCS table, and the service-Table includes at least one bit; and determine the first MCS table from the second type of MCS tables based on the value of the new-mcs-Table carried by the indication information, when the first MCS table is determined to be the second type of MCS tables, where the value of the new-mcs-Table is in one-to-one correspondence with each MCS table in the second type of MCS tables; or determine the first MCS table from the first type of MCS tables based on the value of the mcs-Table carried by the indication information, when the first MCS table is determined to be the first type of MCS tables, where the value of the mcs-Table is in one-to-one correspondence with each MCS table in the first type of MCS tables.

In one embodiment, the processor is further configured to: determine the type of the first MCS table based on the service-Table carried by the indication information, and the service-Table is the newly defined field configured to indicate the type of the MCS table, and the service-Table includes at least one bit; and determine the first MCS table from the second type of MCS tables based on the value of the mcs-Table carried by the indication information, when the first MCS table is determined to be the second type of MCS tables, and the value of the mcs-Table is in one-to-one correspondence with each MCS table in the second type of MCS tables; or determine the first MCS table from the first type of MCS tables based on the value of the mcs-Table carried by the indication information, when the first MCS table is determined to be the first type of MCS tables, where the value of the mcs-Table is in one-to-one correspondence with each MCS table in the first type of MCS tables.

In one embodiment, the processor is further configured to: determine the type of the first MCS table based on the service-Table carried by the indication information, where the service-Table is a newly defined field configured to indicate a type of an MCS table, and the service-Table includes at least one bit; and determine that the first MCS table is the MCS table included in the second type of MCS tables, when the first MCS table is determined to be the second type of MCS tables, and the second type of MCS tables only includes one MCS table.

In one embodiment, when the indication information is the mcs-Table, the processor is further configured to: determine the first MCS table corresponding to the value of the mcs-Table based on the value of the mcs-Table, and the mcs-Table includes at least two bits, the different values of the mcs-Table are configured to indicate different MCS tables, and one value corresponds to one MCS table.

In one embodiment, the first type of MCS tables includes 64 QAM and 256 QAM; and the second type of MCS tables includes at least the MCS table corresponding to the bler-Target of 10⁻⁵.

In one embodiment, provided is a base station that includes: a memory, configured to store instructions; a processor, configured to read the instructions in the memory to execute the following processes: sending RRC signaling carrying indication information to a terminal through a transceiver, to enable the terminal to determine a first MCS table based on the indication information, and the indication information indicates the first MCS table, and the first MCS table is one of a first type of MCS tables and a second type of MCS tables; and the transceiver, configured to receive and send data under the control of the processor.

In one embodiment, the indication information is a cqi-Table, where different values of the cqi-Table indicate different MCS tables, and one value corresponds to one MCS table.

In one embodiment, the indication information carries an mcs-Table; when the first MCS table is the first type of MCS tables, the value of the mcs-Table is in one-to-one correspondence with each MCS table in the first type of MCS tables; or when the first MCS table is the second type of MCS tables, the value of the mcs-Table is in one-to-one correspondence with each MCS table in the second type of MCS tables.

In one embodiment, the processor is further configured to: determine the type of the first MCS table; and determine that a bler-Target does not need to be carried in the indication information, when the first MCS table is determined to be the first type of MCS tables; or determine that the bler-Target needs to be carried in the indication information, when the first MCS table is determined to be the second type of MCS tables.

In one embodiment, when the bler-Target carried by the indication information is a first value, the bler-Target is used to indicate that the first MCS table is the second type of MCS tables; or when the bler-Target carried by the indication information is a second value, the bler-Target is used to indicate that the first MCS table is the second type of MCS tables, and the first value and the second value are used to indicate the different MCS tables included in the second type of MCS tables, respectively; or when the bler-Target carried by the indication information is the second value, the bler-Target is used to indicate that the first MCS table is the first type of MCS tables.

In one embodiment, the processor is further configured to: determine the type of the first MCS table; and determine that a newly defined new-mcs-Table used to indicate the second type of MCS tables needs to be carried in the indication information, when the first MCS table is determined to be the second type of MCS tables, and the value of the new-mcs-Table is in one-to-one correspondence with each MCS table in the second type of MCS tables; or determine that the new-mcs-Table does not need to be carried in the indication information, when the first MCS table is determined to be the first type of MCS tables.

In one embodiment, the indication information includes a service-Table, and the service-Table is a newly defined field used to indicate the type of the MCS table, and the service-Table includes at least one bit; and when the type indicated by the service-Table is the second type of MCS tables, the indication information carries the new-mcs-Table, and the value of the new-mcs-Table is in one-to-one correspondence with each MCS table in the second type of MCS tables; or when the type indicated by the service-Table is the first type of MCS tables, the indication information does not carry the new-mcs-Table, and the value of the mcs-Table carried by the indication information is in one-to-one correspondence with each MCS table in the first type of MCS tables.

In one embodiment, the indication information includes the service-Table, and the service-Table is the newly defined field used to indicate the type of the MCS table, and the service-Table includes at least one bit; and when the type indicated by the service-Table is the second type of MCS tables, the value of the mcs-Table carried by the indication information is in one-to-one correspondence with each MCS table in the second type of MCS tables; or when the type indicated by the service-Table is the first type of MCS tables, the value of the mcs-Table is in one-to-one correspondence with each MCS table in the first type of MCS tables.

In one embodiment, the indication information includes the service-Table, where the service-Table is a newly defined field used to indicate the type of the MCS table, and the service-Table includes at least one bit; and when the type indicated by the service-Table is the second type of MCS tables, and the second type of MCS tables only includes one MCS table, the first MCS table is the MCS table included in the second type of MCS tables.

In one embodiment, the indication information is the mcs-Table, and the mcs-Table includes at least two bits, the different values of the mcs-Table are used to indicate the different MCS tables, and one value corresponds to one MCS table.

In one embodiment, the first type of MCS tables includes 64 QAM and 256 QAM; and the second type of MCS tables at lease includes the MCS table corresponding to the bler-Target of 10⁻⁵.

In one embodiment, provided is a terminal that includes: a receiving device, configured to receive RRC signaling carrying indication information and sent by a base station, and the indication information indicates a first MCS table, and the first MCS table is one of a first type of MCS tables and a second type of MCS tables; and a determination device, configured to determine the first MCS table based on the indication information.

In one embodiment, when the indication information is a cqi-Table, the determination device is configured to: determine the first MCS table corresponding to the value of the cqi-Table based on the value of the cqi-Table, where the different values of the cqi-Table indicate the different MCS tables, and one value corresponds to one MCS table.

In one embodiment, the determination device is configured to: determine the type of the first MCS table based on the indication information; and determine the first MCS table from the first type of MCS tables based on an mcs-Table carried by the indication information, when the first MCS table is determined to be the first type of MCS tables, where the value of the mcs-Table is in one-to-one correspondence with each MCS table in the first type of MCS tables; or determine the first MCS table from the second type of MCS tables based on the mcs-Table carried by the indication information, when the first MCS table is determined to be the second type of MCS tables, where the value of the mcs-Table is in one-to-one correspondence with each MCS table in the second type of MCS tables.

In one embodiment, the determination device is configured to: determine whether the indication information carries a bler-Target; and determine that the first MCS table is the first type of MCS tables, in response to that the indication information does not carry the bler-Target, or determine the first MCS table to be the second type of MCS tables in response to that the indication information carries the bler-Target.

In one embodiment, the determination device is configured to: determine the first MCS table to be the second type of MCS tables, when the bler-Target carried by the indication information is determined to be a first value; or determine the type of the first MCS table based on the value of the cqi-Table carried by the indication information, when the bler-Target carried by the indication information is determined to be a second value.

In one embodiment, the determination device is configured to: determine the first MCS table from the second type of MCS tables based on the value of a new-MCS-Table, when it is determined that the indication information carries the newly defined new-mcs-Table used to indicate the second type of MCS tables, where the value of the new-mcs-Table is in one-to-one correspondence with each MCS table in the second type of MCS tables; or determine the first MCS table from the first type of MCS tables based on the value of the mcs-Table carried by the indication information, when it is determined that the indication information does not carry the new-mcs-Table, and the value of the mcs-Table is in one-to-one correspondence with each MCS table in the first type of MCS tables.

In one embodiment, the determination device is configured to: determine the type of the first MCS table based on service-Table carried by the indication information, and the service-Table is a newly defined field used to indicate the type of the MCS table, and the service-Table includes at least one bit; and determine the first MCS table from the second type of MCS tables based on the value of the new-mcs-Table carried by the indication information, when the first MCS table is determined to be the second type of MCS tables, and the value of the new-mcs-Table is in one-to-one correspondence with each MCS table in the second type of MCS tables; or determine the first MCS table from the first type of MCS tables based on the value of the mcs-Table carried by the indication information, when the first MCS table is determined to be the first type of MCS tables, and the value of the mcs-Table is in one-to-one correspondence with each MCS table in the first type of MCS tables.

In one embodiment, the determination device is configured to: determine the type of the first MCS table based on the service-Table carried by the indication information, and the service-Table is a newly defined field used to indicate the type of the MCS table, and the service-Table includes at least one bit; and determine the first MCS table from the second type of MCS tables based on the value of the mcs-Table carried by the indication information, when the first MCS table is determined to be the second type of MCS tables, and the value of the mcs-Table is in one-to-one correspondence with each MCS table in the second type of MCS tables; or determine the first MCS table from the first type of MCS tables based on the value of the mcs-Table carried by the indication information, when the first MCS table is determined to be the first type of MCS tables, and the value of the mcs-Table is in one-to-one correspondence with each MCS table in the first type of MCS tables.

In one embodiment, the determination device is configured to: determine the type of the first MCS table based on the service-Table carried by the indication information, and the service-Table is a newly defined field used to indicate the type of the MCS table, and the service-Table includes at least one bit; and when the first MCS table is determined to be the second type of MCS tables, and the second type of MCS tables only includes one MCS table, the first MCS table is determined to be the MCS table included in the second type of MCS tables.

In one embodiment, when the indication information is the mcs-Table, the determination device is configured to: determine the first MCS table corresponding to the value of the mcs-Table based on the value of the mcs-Table, and the mcs-Table includes at least two bits, the different values of the mcs-Table are used to indicate the different MCS tables, and one value corresponds to one MCS table.

In one embodiment, the first type of MCS tables includes 64 QAM and 256 QAM; and the second type of MCS tables includes at least the MCS table corresponding to the bler-Target of 10⁻⁵.

In one embodiment, provided is a base station that includes: a sending device, configured to send RRC signaling carrying indication information to a terminal, to enable the terminal to determine a first MCS table based on the indication information, where the indication information indicates the first MCS table, and the first MCS table is one of a first type of MCS tables and a second type of MCS tables.

In one embodiment, the indication information is a cqi-Table, and different values of the cqi-Table indicate different MCS tables, and one value corresponds to one MCS table.

In one embodiment, the indication information carries the mcs-Table; when the first MCS table is the first type of MCS tables, the value of the mcs-Table is in one-to-one correspondence with each MCS table in the first type of MCS tables; or when the first MCS table is the second type of MCS tables, the value of the mcs-Table is in one-to-one correspondence with each MCS table in the second type of MCS tables.

In one embodiment, the base station also includes a first determination device, configured to: determine the type of the first MCS table; and determine that a bler-Target does not need to be carried in the indication information, when the first MCS table is determined to be the first type of MCS tables; or determine that the bler-Target needs to be carried in the indication information, when the first MCS table is determined to be the second type of MCS tables.

In one embodiment, when the bler-Target carried by the indication information is a first value, the bler-Target is used to indicate that the first MCS table is the second type of MCS tables; or when the bler-Target carried by the indication information is a second value, the bler-Target is used to indicate that the first MCS table is the second type of MCS tables, where the first value and the second value are configured to indicate different MCS tables included in the second type of MCS tables, respectively; or when the bler-Target carried by the indication information is the second value, the bler-Target is used to indicate that the first MCS table is the first type of MCS tables.

In one embodiment, the base station also includes a second determination device configured to: determine the type of the first MCS table; and determine that a newly defined new-mcs-Table used to indicate the second type of MCS tables needs to be carried in the indication information, when the first MCS table is determined to be the second type of MCS tables, where the value of the new-mcs-Table is in one-to-one correspondence with each MCS table in the second type of MCS tables; or when the first MCS table is determined to be the first type of MCS tables, it is determined that the new-mcs-Table does not need to be carried in the indication information.

In one embodiment, the indication information includes a service-Table, where the service-Table is a newly defined field used to indicate the type of the MCS table, and the service-Table includes at least one bit; and under the condition that the type indicated by the service-Table is the second type of MCS tables, the indication information carries the new-mcs-Table, and the value of the new-mcs-Table is in one-to-one correspondence with each MCS table in the second type of MCS tables; or when the type indicated by the service-Table is the first type of MCS tables, the indication information does not carry the new-mcs-Table, and the value of the mcs-Table carried by the indication information is in one-to-one correspondence with each MCS table in the first type of MCS tables.

In one embodiment, the indication information includes a service-Table, and the service-Table is a newly defined field used to indicate the type of the MCS table, and the service-Table includes at least one bit; and when the type indicated by the service-Table is the second type of MCS tables, the value of the mcs-Table carried by the indication information is in one-to-one correspondence with each MCS table in the second type of MCS tables; or when the type indicated by the service-Table is the first type of MCS tables, the value of the mcs-Table is in one-to-one correspondence with each MCS table in the first type of MCS tables.

In one embodiment, the indication information includes the service-Table, and the service-Table is the newly defined field used to indicate the type of the MCS table, and the service-Table includes at least one bit; and when the type indicated by the service-Table is the second type of MCS tables, and the second type of MCS tables only includes one MCS table, the first MCS table is the MCS table included in the second type of MCS tables.

In one embodiment, the indication information is the mcs-Table, and the mcs-Table includes at least two bits, the different values of the mcs-Table are used to indicate the different MCS tables, and one value corresponds to one MCS table.

In one embodiment, the first type of MCS tables includes 64 QAM and 256 QAM; and the second type of MCS tables includes at least the MCS table corresponding to the bler-Target of 10⁻⁵.

In one embodiment, provided is a readable storage medium; a computer command is stored in the readable storage medium, and when the computer command is run on a computer, the computer executes the method according to other embodiments of the disclosure.

### BRIEF DESCRIPTION OF THE DRAWINGS

FIG. 1 is a schematic diagram of a method for determining an MCS table provided by an embodiment of the present disclosure.

FIG. 2 is a schematic diagram of a structure of a terminal provided by an embodiment of the present disclosure.

FIG. 3 is a schematic diagram of a structure of a base station provided by an embodiment of the present disclosure.

FIG. 4 is a schematic diagram of another structure of a terminal provided by an embodiment of the present disclosure.

FIG. 5 is a schematic diagram of another structure of a base station provided by an embodiment of the present disclosure.

### DETAILED DESCRIPTION OF THE EMBODIMENTS

At present, for a terminal, eMBB service and URLLC service may be supported at the same time, and the URLLC service may also correspond to a plurality of different bler-Targets, e.g., for the URLLC service, the bler-Target at initial transmission may be 10⁻¹, while the bler-Target at retransmission may be 10⁻⁵. At present, for eMBB, RRC signaling includes an information element (IE) used to indicate MCS tables, namely an mcs-Table which takes one bit, that is, two MCS tables may be indicated corresponding to the two MCS table types of eMBB, namely 64 QAM and 256 QAM. However, the MCS table defined for URLLC cannot be indicated at present, so that the terminal cannot determine the currently used MCS table, and thus a communication process cannot be accurately carried out, and user experience is not good.

Therefore, an embodiment of the present disclosure provides a method for determining an MCS table. In the method, a first MCS table indicated by indication information may be one of a first type of MCS tables and a second type of MCS tables. That is, the indication information may indicate a plurality of MCS table types, such as the MCS table corresponding to eMBB and the MCS table corresponding to URLLC, so that the terminal can correctly determine the MCS table used by current service, and thus the correct proceeding of the communication process is ensured, and the quality of user communication experience is enhanced.

The embodiments of the present disclosure are introduced below in combination with the accompanying drawings.

Referring to FIG. 1, an embodiment of the present disclosure provides a method for determining an MCS table, which can be performed by a base station and a terminal provided by the embodiments of the present disclosure. Since interaction between the base station and the terminal is involved, the methods of the base station and the terminal will be described together in following process description of the methods.

S101, the base station sends RRC signaling carrying indication information to the terminal, and the terminal receives the RRC signaling.

In the embodiments of the present disclosure, in order to enable the terminal to correctly acquire an MCS table used in a current communication process, the base station needs to indicate the used MCS table to the terminal, so that the base station can send the indication information to the terminal by carrying the indication information in the RRC signaling, where the indication information is used to indicate the used first MCS table.

In one embodiment, in the related art, eMBB service also corresponds to two MCS tables, namely 64 QAM and 256 QAM, and the two MCS tables corresponding to the eMBB service are referred to as a first type of MCS tables. In addition, at present, one or more MCS tables can also be newly added for URLLC service, for example, the newly added tables may include the MCS tables corresponding to the bler-Target of 10⁻⁵ and the MCS tables corresponding to the bler-Target of 10⁻¹ or other values, and the one or more MCS tables corresponding to the URLLC service are referred to herein as a second type of MCS tables, so that the first MCS table may be one of the first type of MCS tables and the second type of MCS tables.

S102, the terminal determines the first MCS table based on the indication information.

In the embodiments of the present disclosure, after the terminal receives the RRC signaling carrying the indication information sent by the base station, the indication information in the RRC signaling can be obtained, so that the terminal can determine the first MCS table on the basis of the indication information.

In one embodiment, there may be various embodiments of the indication information, which will be described separately below.

### Embodiment 1

In the embodiments of the present disclosure, the indication information may be a cqi-Table, where the cqi-Table takes two bits, so that the two bits of the cqi-Table may have four values, the different values of the cqi-Table can be used to indicate the different MCS tables, and one value corresponds to one MCS table. For example, the four values may be “00”, “01”, “10” and “11”, and then may correspond to at most four MCS tables. For example, the first two values may correspond to the MCS tables included in the first type of MCS tables, i.e., “00” corresponds to 64 QAM and “01” corresponds to 256 QAM, and the latter two values may be used to correspond to the MCS tables included in the second type of MCS tables, of course, when there is only one MCS table included in the second type of MCS tables, the last value may be a blank value, i.e. not corresponding to any MCS table. Under the condition that the second type of MCS tables only includes the MCS table corresponding to the bler-Target of 10⁻⁵, “10” may be used to correspond to the MCS table corresponding to the bler-Target of 10⁻⁵.

In the embodiments of the present disclosure, after the base station determines the first MCS table configured for the terminal, the cqi-Table sent to the terminal can be set to a corresponding value, and the terminal can also determine the first MCS table corresponding to the value of the cqi-Table according to the received value of the cqi-Table.

For example, under the condition that the base station determines that the first MCS table configured for the terminal is 64 QAM, the base station sets the cqi-Table to be “00”. Correspondingly, after the terminal receives the cqi-Table, it can be detected that the value of the cqi-Table is “00”, and the terminal can determine that a channel quality indicator (CQI) is 64 QAM, and meanwhile can know that the first MCS table is 64 QAM.

Or, under the condition that the base station determines that the first MCS table configured for the terminal is 256 QAM, the base station sets the cqi-Table to be “01”. Correspondingly, after the terminal receives the cqi-Table, it can be detected that the value of the cqi-Table is “01”, and the terminal can determine that the CQI is 256 QAM and meanwhile can know that the first MCS table is 256 QAM.

Or, under the condition that the base station determines that the first MCS table configured for the terminal is the MCS table corresponding to the bler-Target of 10⁻⁵, the base station sets the cqi-Table to be “10”. Correspondingly, after the terminal receives the cqi-Table, it can be detected that the value of the cqi-Table is “10”, and the terminal can determine that the CQI is the CQI corresponding to the bler-Target of 10⁻⁵, and meanwhile can know that the first MCS table is the MCS table corresponding to the bler-Target of 10⁻⁵.

It should be noted that Embodiment 1 may be applied to the case where one CQI is configured.

### Embodiment 2

In the embodiments of the present disclosure, the indication information can also indicate the type of the first MCS table, and then the terminal can determine the type of the first MCS table on the basis of the indication information.

In one embodiment, the type of the first MCS table may be determined through the condition whether the indication information carries the bler-Target or not. In one embodiment, when the indication information carries the bler-Target, it can be indicated that the current service is URLLC, that is, the first MCS table is the second type of MCS tables; otherwise, under the condition that the indication information does not carry the bler-Target, it can be indicated that the current service is eMBB, that is, the first MCS table is the first type of MCS tables. For example, the indication information may be a channel quality information configuration report (CSI-Report Config) that is used to indicate that the first MCS table is the first type of MCS tables when the bler-Target is not included in the CSI-Report Config, or that is used to indicate that the first MCS table is the second type of MCS tables when the bler-Target is included in the CSI-Report Config.

Therefore, when the base station determines that the first MCS table configured for the terminal is the first type of MCS tables, the base station can determine that the bler-Target does not need to be carried in the indication information, and correspondingly, after the terminal receives the indication information, when it is determined that the bier-Target is not carried in the indication information, the first MCS table can be determined to be the first type of MCS tables.

Or, when the base station determines that the first MCS table configured for the terminal is the second type of MCS tables, the base station can determine that the bier-Target needs to be carried in the indication information; and correspondingly, after the terminal receives the indication information, when it is determined that the bier-Target is carried in the indication information, the first MCS table can be determined to be the second type of MCS tables.

In one embodiment, the type of the first MCS table can also be jointly determined through the bier-Target and the cqi-Table carried by the indication information. In one embodiment, when the bier-Target is the first value, the bier-Target is used to indicate that the first MCS table is the second type of MCS tables; or, when the bier-Target is the second value, the bier-Target is used to indicate that the first MCS table is the second type of MCS tables, and the first value and the second value are respectively used to indicate different MCS tables included in the second type of MCS tables; or, when the bier-Target is the second value, the bier-Target is used to indicate that the first MCS table is the first type of MCS tables.

The bier-Target includes at least one value, i.e. may include 10⁻⁵, and may also include 10⁻¹ and other values.

The cqi-Table includes two bits, and the plurality of values of the cqi-Table are called C1, C2, C3 and C4 in implementation; the cqi-Table may have a plurality of definition modes; the first definition mode is that C1 corresponds to 64 QAM, C2 corresponds to 256 QAM, C3 corresponds to URLLC new1, and C4 corresponds to URLLC new2, that is, two MCS table types are defined for URLLC, and URLLC new1 refers to the MCS table corresponding to the bier-Target of 10⁻⁵, and URLLC new2 refers to the MCS table corresponding to the bier-Target of 10⁻¹; the second definition mode is that C1 corresponds to 64 QAM, C2 corresponds to 256 QAM, and C3 corresponds to URLLC new and C4 is a blank value, that is, one MCS table type is defined for URLLC, and URLLC new refers to the MCS table corresponding to the bier-Target of 10⁻⁵; and the third definition mode is that C1 corresponds to 64 QAM or URLLC new, C2 corresponds to 256 QAM or URLLC new, and C3 and C4 are the blank values.

Determination of the type of the first MCS table through the bier-Target and the cqi-Table together is described below under the condition that the bier-Target includes 10⁻⁵ and 10⁻¹, and the cqi-Table is defined in the first mode.

When the value of the bier-Target received by the terminal is the first value, i.e., the bier-Target is determined to be 10⁻⁵, the terminal can directly determine that the first MCS table is the second type of MCS tables.

When the value of the bler-Target received by the terminal is the second value, i.e., the bler-Target is determined to be 10⁻¹, the terminal can directly determine the type of the first MCS table on the basis of the value of the cqi-Table. In one embodiment, when the value of the cqi-Table is C1 or C2, the terminal can determine that the first MCS table is the first type of MCS tables, and when the value of the cqi-Table is C3 or C4, the terminal can determine that the first MCS table is the second type of MCS tables.

In the embodiments of the present disclosure, after the terminal determines the type of the first MCS table, the first MCS table can be determined on the basis of the mcs-Table carried by the indication information.

In one embodiment, the mcs-Table is defined in the related art, and the two effective values of the mcs-Table correspond to 64 QAM and 256 QAM, respectively. However, since the MCS table corresponding to URLLC is added at present, the mcs-Table is not merely used to indicate the two tables corresponding to the eMBB. In one embodiment, when the first MCS table is the first type of MCS tables, the value of the mcs-Table is in one-to-one correspondence with each MCS table in the first type of MCS tables; or when the first MCS table is the second type of MCS tables, the value of the mcs-Table is in one-to-one correspondence with each MCS table in the second type of MCS tables.

In one embodiment, when the terminal determines that the first MCS table is the first type of MCS tables, the terminal can determine the first MCS table from the first type of MCS tables on the basis of the value of the mcs-Table.

For example, under the condition that the terminal detects that the bler-Target is not carried in the indication information, the terminal can determine that the first MCS table is the first type of MCS tables, and then the terminal can determine the first MCS table from the first type of MCS tables, i.e., when the value of the mcs-Table is “0”, the terminal can determine that the first MCS table is 64 QAM, or when the value of the mcs-Table is “1”, the terminal can determine that the first MCS table is 256 QAM.

Or, under the condition that the terminal detects that the value of the bler-Target carried by the indication information is “00”, the terminal can determine that the bler-Target is 10⁻¹, and under the condition that the terminal determines that the value of the cqi-Table is “00” or “01”, namely C1 or C2, the terminal can determine that the first MCS table is the first type of MCS tables, and then the terminal can determine the first MCS table from the first type of MCS tables, that is, when the value of the mcs-Table is “0”, the terminal can determine that the first MCS table is 64 QAM, or, when the value of the mcs-Table is “1”, the terminal can determine that the first MCS table is 256 QAM.

In one embodiment, when the terminal determines that the first MCS table is the second type of MCS tables, the terminal can determine the first MCS table from the second type of MCS tables according to the value of the mcs-Table.

For example, under the condition that the terminal detects that the bler-Target is carried in the indication information, the terminal can determine that the first MCS table is the second type of MCS tables, and then the terminal can determine the first MCS table from the second type of MCS tables, i.e., when the value of the mcs-Table is “0”, the terminal can determine that the first MCS table is the MCS table corresponding to the bler-Target of 10⁻⁵, or when the value of the mcs-Table is “1”, the terminal can determine that the first MCS table is the MCS table corresponding to the bler-Target of 10⁻¹.

Or, under the condition that the terminal detects that the value of the bler-Target carried by the indication information is “01”, the terminal can determine that the bler-Target is 10⁻⁵, and then the current service is the URLLC service. Under the condition that the terminal determines that the value of the cqi-Table is “10” or “11”, namely C3 or C4, the terminal can determine that the first MCS table is the second type of MCS tables, and then the terminal can determine the first MCS table from the second type of MCS tables, that is, when the value of the mcs-Table is “0”, the terminal can determine that the first MCS table is the MCS table corresponding to the bler-Target of 10⁻⁵, or when the value of the mcs-Table is “1”, the terminal can determine that the first MCS table is the MCS table corresponding to the bler-Target of 10⁻¹.

Correspondingly, the base station can set the values of the bler-Target, the cqi-Table and the mcs-Table for the type of the first MCS table and for which MCS table.

It should be noted that Embodiment 2 may be applied to the case where two CQIs are configured.

### Embodiment 3

In the embodiments of the present disclosure, the MCS table corresponding to the

URLLC is defined for the URLLC, so that the newly defined field new-mcs-Table can also be added in the RRC signaling, and the new field is specially used to indicate the second type of MCS tables. Of course, the name of the field can also be set to other possible names, and the subject of the embodiment of the present disclosure is to illustrate a thought thereof and not to limit the specific embodiments.

In one embodiment, when the new-mcs-Table is carried in the indication information, it is indicated that the used MCS table is the second type of MCS tables, and if the new-mcs-Table is not carried in the indication information, it is indicated that the used MCS table is the first type of MCS tables.

In the embodiments of the present disclosure, the base station can determine the type of the first MCS table configured for the terminal to determine whether the new-mcs-Table needs to be carried in the indication information or not.

In one embodiment, when the base station determines that the first MCS table is the first type of MCS tables, the base station can determine that the new-mcs-Table does not need to be carried in the indication information. Correspondingly, after the terminal receives the indication information, it can also be detected that the new-mcs-Table is not carried in the indication information, and then the terminal can determine the first MCS table on the basis of the mcs-Table carried in the indication information.

In one embodiment, when the base station determines that the first MCS table is the second type of MCS tables, the base station can determine that the new-mcs-Table needs to be carried in the indication information. Correspondingly, after the terminal receives the indication information, it can also be detected that the new-mcs-Table is carried in the indication information, and then the terminal can determine that the first MCS table is the second type of MCS tables, and the terminal can determine the first MCS table on the basis of the value of the new-mcs-Table.

For example, when the terminal detects the new-mcs-Table in the indication information and the value of the new-mcs-Table is “0”, the terminal can determine that the first MCS table is the MCS table of the URLLC new1, i.e., the MCS table corresponds to the bler-Target of 10⁻⁵.

Or, when the terminal detects the new-mcs-Table in the indication information and the value of the new-mcs-Table is “1”, the terminal can determine that the first MCS table is the MCS table of the URLLC new2, i.e., the MCS table corresponds to the bler-Target of 10⁻¹.

The mcs-Table is inevitably carried in the current indication information, and when the new-mcs-Table is also carried in the indication information, it can be considered that the mcs-Table is invalid. Of course, it may be possible to configure the attribute of the mcs-Table as an optional attribute and configure the attribute of the new-mcs-Table as an optional attribute; then it may be considered that the first MCS table is the second type of MCS tables when the new-mcs-Table is carried and the mcs-Table is not carried in the indication information; and it may be considered that the first MCS table is the first type of MCS tables when the mcs-Table is carried and the new-mcs-Table is not carried in the indication information.

It should be noted that Embodiment 3 may be applied to the case where the plurality of CQIs are configured.

### Embodiment 4

In the embodiments of the present disclosure, the mcs-Table in the related art can be expanded, for example, the existing mcs-Table is expanded from one bit to two bits to support more MCS tables; and then the indication information may also be the mcs-Table, and the mcs-Table includes at least two bits, the different values of the mcs-Table are used to indicate the different MCS tables, and one value corresponds to one MCS table.

In one embodiment, after the base station determines the first MCS table configured for the terminal, the mcs-Table sent to the terminal can be set to the corresponding value, and the terminal can also determine the first MCS table corresponding to the value of the mcs-Table on the basis of the received value of the mcs-Table.

For example, under the condition that the base station determines that the first MCS table configured for the terminal is 64 QAM, the base station sets the mcs-Table to be “00”. Correspondingly, after the terminal receives the mcs-Table, it can be detected that the value of the mcs-Table is “00”, and the terminal can also determine that the first MCS table is 64 QAM.

Or, under the condition that the base station determines that the first MCS table configured for the terminal is 256 QAM, the base station sets the mcs-Table to be “01”. Correspondingly, after the terminal receives the mcs-Table, it can be detected that the value of the mcs-Table is “01”, and the terminal can also determine that the first MCS table is 256 QAM.

Or, under the condition that the base station determines that the first MCS table configured for the terminal is the MCS table corresponding to the bler-Target of 10⁻⁵, the base station sets the mcs-Table to be “10”. Correspondingly, after the terminal receives the mcs-Table, it can be detected that the value of the mcs-Table is “10”, and the terminal can also determine that the first MCS table is the MCS table corresponding to the bler-Target of 10⁻⁵.

### Embodiment 5

In the embodiments of the present disclosure, in order to distinguish the MCS tables corresponding to the eMBB and the URLLC, the field service-Table can be newly defined, and the service-Table includes at least one bit and used to indicate the type of the MCS table.

In one embodiment, after the base station determines the first MCS table configured for the terminal, the base station can know the type of the first MCS table to assign a corresponding value to the service-Table and send the service-Table to the terminal. Correspondingly, after receiving the service-Table, the terminal can know the type of the first MCS table on the basis of the value of the service-Table.

In the embodiments of the present disclosure, when the service-Table is not carried in the RRC signaling sent by the base station, the indicated first MCS table can be the first type of MCS tables by default.

In the embodiments of the present disclosure, although the type of the first MCS table is indicated through the service-Table, the terminal cannot determine that which MCS table is the first MCS table, so that in order to accurately determine that which MCS table is the first MCS table by the terminal, the base station also needs to indicate that which MCS table is the first MCS table to the terminal. Of course, under the condition that the second type of MCS tables only includes one MCS table, the terminal can directly determine that the first MCS table is the only MCS table in the second table type after determining that the first MCS table is the second type of MCS tables on the basis of the service-Table.

### First Indication Mode

The base station can indicate the MCS tables included in the second type of MCS tables through the newly defined field new-mcs-Table and indicate the MCS tables included in the first type of MCS tables through the mcs-Table.

In one embodiment, under the condition that the first MCS table is the second type of MCS tables, the base station can indicate the different MCS tables included in the second type of MCS tables to the terminal by carrying the new-mcs-Table in the indication information and then assigning different values to the new-mcs-Table. And after receiving the new-mcs-Table, the terminal can determine a first MCS value from the second type of MCS tables according to the new-mcs-Table value, and the new-mcs-Table value is in one-to-one correspondence with each MCS table in the second type of MCS tables.

In one embodiment, under the condition that the first MCS table is the first type of MCS tables, the base station still can indicate the different MCS tables included in the first type of MCS tables to the terminal through the mcs-Table. And after the terminal receives the mcs-Table, the terminal can determine the first MCS value from the first type of MCS tables on the basis of the value of the mcs-Table, and the value of the mcs-Table is in one-to-one correspondence with each MCS table in the first type of MCS tables.

### Second Indication Mode

The base station can indicate the MCS tables included in the first type of MCS tables or the MCS tables included in the second type of MCS tables through the mcs-Table.

In one embodiment, under the condition that the first MCS table is the second type of MCS tables, the value of the mcs-Table carried by the indication information sent by the base station to the terminal is in one-to-one correspondence with each MCS table in the second type of MCS tables, that is, the first MCS table is jointly determined through the service-Table and the mcs-Table. And after the terminal receives the indication information, firstly, the first MCS table can be determined to be the second type of MCS tables on the basis of the value of the service-Table, and then the first MCS table is determined from the second type of MCS tables on the basis of the value of the mcs-Table.

Under the condition that the type indicated by the service-Table is the first type of MCS tables, the value of the mcs-Table carried by the indication information sent to the terminal by the base station is in one-to-one correspondence with each MCS table in the first type of MCS tables. And after the terminal receives the indication information, firstly, the first MCS table can be determined to be the first type of MCS tables according to the value of the service-Table, and then the first MCS table is determined from the first type of MCS tables according to the value of the mcs-Table.

In the embodiments of the present disclosure, the base station can also send a MCS index to the terminal through a physical downlink control channel (PDCCH), and correspondingly, the terminal can also receive the MCS index through the PDCCH, so that the terminal can determine the MCS value according to the MCS index and the determined first MCS table, and then detect a physical uplink shared channel (PUSCH) and a physical downlink shared channel (PDSCH) on the basis of the determined MCS value.

In the embodiments of the present disclosure, a semi-static indication mode is also provided for the newly added MCS table, so that the terminal can correctly determine the MCS table used by the current service, and thus the correct proceeding of the communication process is ensured, and the quality of user communication experience is improved.

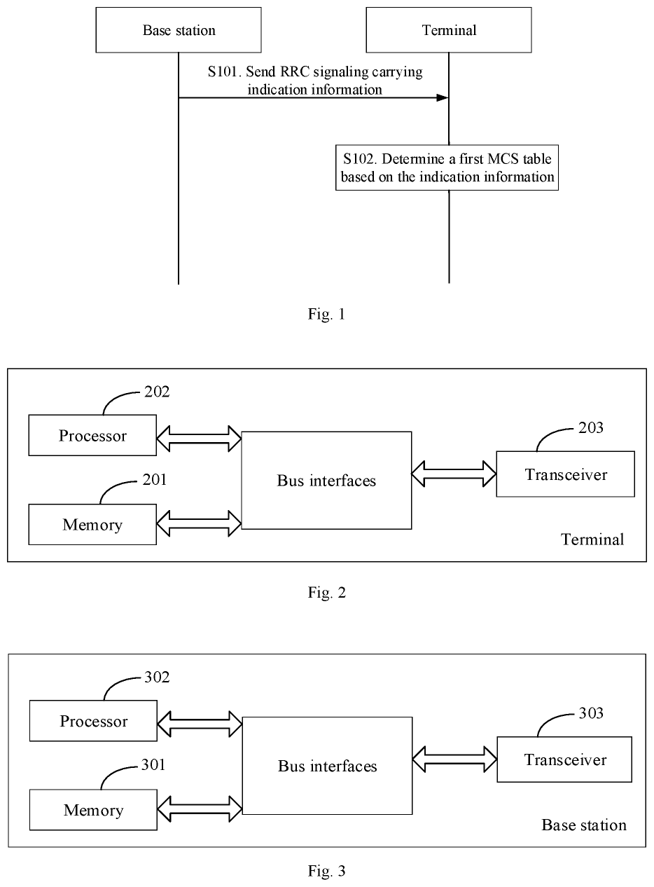

Referring to FIG. 2, based on the same inventive concept, an embodiment of the present disclosure also provides a terminal including a memory 201, a processor 202, and a transceiver 203. The memory 201 and the transceiver 203 can be connected to the processor 202 via a bus interface (which is taken as an example in FIG. 2), or connected to the processor 202 through a connection line.

The memory 201 can be configured to store one or more programs. The transceiver is configured to receive and transmit data under the control of the processor. The processor 202 can be configured to read the programs in the memory 201, to execute the following processes: radio resource control (RRC) signaling sent by the base station and carrying indication information is received through the transceiver, and the indication information is used to indicate a first MCS table, and the first MCS table is one of a first type of MCS tables and a second type of MCS tables; and the first MCS table is determined on the basis of the indication information.

In one embodiment, under the condition that the indication information is a cqi-Table, the processor 202 is configured to: determine the first MCS table corresponding to the value of the cqi-Table on the basis of the value of the cqi-Table, and the different values of the cqi-Table are used to indicate the different MCS tables, and one value corresponds to one MCS table.

In one embodiment, the processor 202 is configured to: determine the type of the first MCS table on the basis of the indication information; and determine the first MCS table from the first type of MCS tables on the basis of an mcs-Table carried by the indication information, under the condition that the first MCS table is determined to be the first type of MCS tables, and the value of the mcs-Table is in one-to-one correspondence with each MCS table in the first type of MCS tables; or determine the first MCS table from the second type of MCS tables on the basis of the mcs-Table carried by the indication information, under the condition that the first MCS table is determined to be the second type of MCS tables, and the value of the mcs-Table is in one-to-one correspondence with each MCS table in the second type of MCS tables.

In one embodiment, the processor 202 is configured to: determine whether the indication information carries a bler-Target or not; and determine the first MCS table to be the first type of MCS tables, when it is determined that the indication information does not carry the bler-Target; and when it is determined that the indication information carries the bler-Target, determine the first MCS table to be the second type of MCS tables.

In one embodiment, the processor 202 is configured to: determine the first MCS table to be the second type of MCS tables, when the bler-Target carried by the indication information is determined to be a first value; or determine the type of the first MCS table on the basis of the value of the CQI-Table carried by the indication information, when the bler-Target carried by the indication information is determined to be a second value.

In one embodiment, the processor 202 is configured to: determine the first MCS table from the second type of MCS tables on the basis of the value of a new-mcs-Table, under the condition that it is determined that the indication information caries the newly defined new-mcs-Table used to indicate the second type of MCS tables, and the value of the new-mcs-Table is in one-to-one correspondence with each MCS table in the second type of MCS tables; or determine the first MCS table from the first type of MCS tables on the basis of the value of the mcs-Table carried by the indication information, under the condition that it is determined that the indication information does not carry the new-mcs-Table, and the value of the mcs-Table is in one-to-one correspondence with each MCS table in the first type of MCS tables.

In one embodiment, the processor 202 is configured to: determine the type of the first MCS table on the basis of the service-Table carried by the indication information, and the service-Table is a newly defined field used to indicate the type of the MCS table, and the service-Table includes at least one bit; and determine the first MCS table from the second type of MCS tables on the basis of the value of the new-mcs-Table carried by the indication information, under the condition that the first MCS table is determined to be the second type of MCS tables, and the value of the new-mcs-Table is in one-to-one correspondence with each MCS table in the second type of MCS tables; or determine the first MCS table from the first type of MCS tables on the basis of the value of the mcs-Table carried by the indication information, under the condition that the first MCS table is determined to be the first type of MCS tables, and the value of the mcs-Table is in one-to-one correspondence with each MCS table in the first type of MCS tables.

In one embodiment, the processor 202 is configured to: determine the type of the first MCS table on the basis of the service-Table carried by the indication information, and the service-Table is the newly defined field used to indicate the type of the MCS table, and the service-Table includes at least one bit; and determine the first MCS table from the second type of MCS tables on the basis of the value of the mcs-Table carried by the indication information, under the condition that the first MCS table is determined to be the second type of MCS tables, and the value of the mcs-Table is in one-to-one correspondence with each MCS table in the second type of MCS tables; or determine the first MCS table from the first type of MCS tables on the basis of the value of the mcs-Table carried by the indication information, under the condition that the first MCS table is determined to be the first type of MCS tables, and the value of the mcs-Table is in one-to-one correspondence with each MCS table in the first type of MCS tables.

In one embodiment, the processor 202 is configured to: determine the type of the first MCS table on the basis of the service-Table carried by the indication information, and the service-Table is the newly defined field used to indicate the type of the MCS table, and the service-Table includes at least one bit; and determine the first MCS table to be the MCS table included in the second type of MCS tables, under the condition that the first MCS table is determined to be the second type of MCS tables, and the second type of MCS tables only includes one MCS table.

In one embodiment, under the condition that the indication information is the mcs-Table, the processor 202 is configured to: determine the first MCS table corresponding to the value of the mcs-Table on the basis of the value of the mcs-Table, and the mcs-Table includes at least two bits, the different values of the mcs-Table are used to indicate the different MCS tables, and one value corresponds to one MCS table.

In one embodiment, the first type of MCS tables includes 64 QAM and 236 QAM; and the second type of MCS tables at lease includes the MCS table corresponding to the bler-Target of 10⁻³.

In FIG. 2, a bus architecture may comprise any numbers of buses and bridges connected to each other, and one or more processors represented by the processor 202 and various circuits of memories represented by the memory 201 are linked together. The bus architecture may also link other various circuits together, such as peripheral equipment, voltage stabilizers and power management circuits, which are all well known in this field, and thus will not be further described herein. Bus interfaces provide interfaces. The transceiver 203 may comprise a plurality of elements, namely including a transmitter and a receiver, and provides devices communicating with other devices on a transmission medium. The processor 202 is responsible for managing the bus architecture and generally processing, and the memory 201 can store data used by the processor 202 when the processor performs operation.

Referring to FIG. 3, based on the same inventive concept, an embodiment of the present disclosure also provides a base station including a memory 301, a processor 302, and a transceiver 303. The memory 301 and the transceiver 303 may be connected to the processor 302 via a bus interface (which is taken as an example in FIG. 3), or connected to the processor 302 through a connection line.

The memory 301 can be configured to store a program. The transceiver is configured to receive and transmit data under the control of the processor. The processor 302 can be configured to read the program in the memory 301, to execute the following process: RRC signaling carrying indication information is sent to a terminal through a transceiver 303, and thus allowing the terminal to be able to determine a first MCS table on the basis of the indication information, and the indication information is used to indicate the first MCS table, and the first MCS table is one of a first type of MCS tables and a second type of MCS tables; and In one embodiment, the indication information is a cqi-Table, and the different values of the cqi-Table are used to indicate the different MCS tables, and one value corresponds to one MCS table.

In one embodiment, an mcs-Table is carried in the indication information; when the first MCS table is the first type of MCS tables, the value of the mcs-Table is in one-to-one correspondence with each MCS table in the first type of MCS tables; or when the first MCS table is the second type of MCS tables, the value of the mcs-Table is in one-to-one correspondence with each MCS table in the second type of MCS tables.

In one embodiment, the processor 302 is further configured to: determine the type of the first MCS table; and determine that a bler-Target does not need to be carried in the indication information, when the first MCS table is determined to be the first type of MCS tables; or determine that the bler-Target needs to be carried in the indication information, when the first MCS table is determined to be the second type of MCS tables.

In one embodiment, when the bler-Target carried by the indication information is a first value, the bler-Target is used to indicate that the first MCS table is the second type of MCS tables; or when the bler-Target carried by the indication information is a second value, the bler-Target is used to indicate that the first MCS table is the second type of MCS tables, and the first value and the second value are used to indicate the different MCS tables included in the second type of MCS tables, respectively; or when the bler-Target carried by the indication information is the second value, the bler-Target is used to indicate that the first MCS table is the first type of MCS tables.

In one embodiment, the processor 302 is further configured to: determine the type of the first MCS table; and determine that a newly defined new-mcs-Table used to indicate the second type of MCS tables needs to be carried in the indication information, when the first MCS table is determined to be the second type of MCS tables, and the value of the new-mcs-Table is in one-to-one correspondence with each MCS table in the second type of MCS tables; or determine that the new-mcs-Table does not need to be carried in the indication information, when the first MCS table is determined to be the first type of MCS tables.

In one embodiment, the indication information includes a service-Table, and the service-Table is a newly defined field used to indicate the type of the MCS table, and the service-Table includes at least one bit; and under the condition that the type indicated by the service-Table is the second type of MCS tables, the indication information carries the new-mcs-Table, and the value of the new-mcs-Table is in one-to-one correspondence with each MCS table in the second type of MCS tables; or under the condition that the type indicated by the service-Table is the first type of MCS tables, the indication information does not carry the new-mcs-Table, and the value of the mcs-Table carried by the indication information is in one-to-one correspondence with each MCS table in the first type of MCS tables.

In one embodiment, the indication information includes the service-Table, and the service-Table is the newly defined field used to indicate the type of the MCS table, and the service-Table includes at least one bit; and under the condition that the type indicated by the service-Table is the second type of MCS tables, the value of the mcs-Table carried by the indication information is in one-to-one correspondence with each MCS table in the second type of MCS tables; or under the condition that the type indicated by the service-Table is the first type of MCS tables, the value of the mcs-Table is in one-to-one correspondence with each MCS table in the first type of MCS tables.

In one embodiment, the indication information includes the service-Table, and the service-Table is the newly defined field used to indicate the type of the MCS table, and the service-Table includes at least one bit; and under the condition that the type indicated by the service-Table is the second type of MCS tables, and the second type of MCS tables only includes one MCS table, the first MCS table is the MCS table included in the second type of MCS tables.

In one embodiment, the indication information is the mcs-Table, and the mcs-Table includes at least two bits, the different values of the mcs-Table are used to indicate the different MCS tables, and one value corresponds to one MCS table.

In one embodiment, the first type of MCS tables includes 64 QAM and 256 QAM; and the second type of MCS tables at lease includes the MCS table corresponding to the bler-Target of 10⁻⁵.

In the FIG. 3, a bus architecture may comprise any numbers of buses and bridges connected to each other, and one or more processors represented by the processor 302 and various circuits of memories represented by the memory 301 are linked together. The bus architecture may also link other various circuits together, such as peripheral equipment, voltage stabilizers and power management circuits, which are all well known in this field, and thus will not be further described herein. Bus interfaces provide interfaces. The transceiver 303 may comprise a plurality of elements, namely including a transmitter and a receiver, and provides devices communicating with other devices on a transmission medium. The processor 302 is responsible for managing the bus architecture and generally processing, and the memory 301 can store data used by the processor 302 when the processor performs operation.

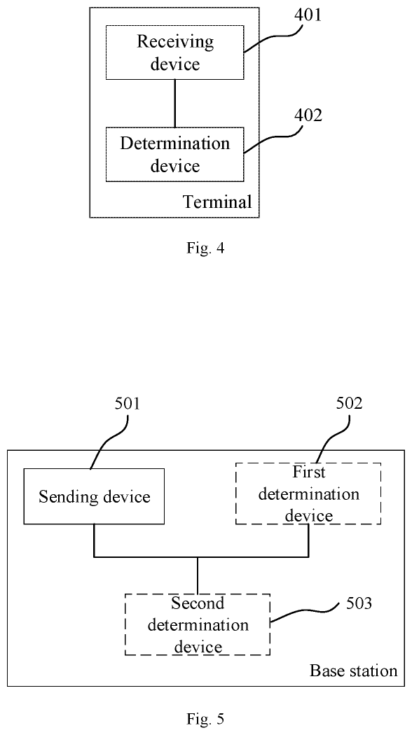

Referring to FIG. 4, based on the same inventive concept, an embodiment of the present disclosure provides a terminal, including a receiving device 401, configured to receive radio resource control (RRC) signaling carrying indication information and sent by a base station, and the indication information is used to indicate a first MCS table, and the first MCS table is one of a first type of MCS tables and a second type of MCS tables; and a determination device 402, configured to determine the first MCS table on the basis of the indication information.

In one embodiment, under the condition that the indication information is a cqi-Table, the determination device 402 is configured to: determine the first MCS table corresponding to the value of the cqi-Table on the basis of the value of the cqi-Table, and the different values of the cqi-Table are used to indicate different MCS tables, and one value corresponds to one MCS table.

In one embodiment, the determination device 402 is configured to: determine the type of the first MCS table on the basis of the indication information; and determine the first MCS table from the first type of MCS tables on the basis of an mcs-Table carried by the indication information, under the condition that the first MCS table is determined to be the first type of MCS tables, and the value of the mcs-Table is in one-to-one correspondence with each MCS table in the first type of MCS tables; or determine the first MCS table from the second type of MCS tables on the basis of the mcs-Table carried by the indication information, under the condition that the first MCS table is determined to be the second type of MCS tables, and the value of the mcs-Table is in one-to-one correspondence with each MCS table in the second type of MCS tables.

In one embodiment, the determination device 402 is configured to: determine whether the indication information carries bler-Target or not; and determine the first MCS table to be the second type of MCS tables, when it is determined that the indication information does not carry the bler-Target; and otherwise, determine the first MCS table to be the second type of MCS tables.

In one embodiment, the determination device 402 is configured to: determine the first MCS table to be the second type of MCS tables, when the bler-Target carried by the indication information is determined to be a first value; or determine the type of the first MCS table on the basis of the value of the CQI-Table carried by the indication information, when the bler-Target carried by the indication information is determined to be a second value.

In one embodiment, the determination device 402 is configured to: determine the first MCS table from the second type of MCS tables on the basis of the value of a new-mcs-Table, under the condition that it is determined that the indication information carries the newly defined new-mcs-Table used to indicate the second type of MCS tables, and the value of the new-mcs-Table is in one-to-one correspondence with each MCS table in the second type of MCS tables; or determine the first MCS table from the first type of MCS tables on the basis of the value of the mcs-Table carried by the indication information, under the condition that it is determined that the indication information does not carry the new-mcs-Table, and the value of the mcs-Table is in one-to-one correspondence with each MCS table in the first type of MCS tables.

In one embodiment, the determination device 402 is configured to: determine the type of the first MCS table on the basis of the service-Table carried by the indication information, and the service-Table is the newly defined field used to indicate the type of the MCS table, and the service-Table includes at least one bit; and determine the first MCS table from the second type of MCS tables on the basis of the value of the new-mcs-Table carried by the indication information, under the condition that the first MCS table is determined to be the second type of MCS tables, and the value of the new-mcs-Table is in one-to-one correspondence with each MCS table in the second type of MCS tables; or determine the first MCS table from the first type of MCS tables on the basis of the value of the mcs-Table carried by the indication information, under the condition that the first MCS table is determined to be the first type of MCS tables, and the value of the mcs-Table is in one-to-one correspondence with each MCS table in the first type of MCS tables.

In one embodiment, the determination device 402 is configured to: determine the type of the first MCS table on the basis of the service-Table carried by the indication information, and the service-Table is the newly defined field used to indicate the type of the MCS table, and the service-Table includes at least one bit; and determine the first MCS table from the second type of MCS tables on the basis of the value of the mcs-Table carried by the indication information, under the condition that the first MCS table is determined to be the second type of MCS tables, and the value of the mcs-Table is in one-to-one correspondence with each MCS table in the second type of MCS tables; or determine the first MCS table from the first type of MCS tables on the basis of the value of the mcs-Table carried by the indication information, under the condition that the first MCS table is determined to be the first type of MCS tables, and the value of the mcs-Table is in one-to-one correspondence with each MCS table in the first type of MCS tables.

In one embodiment, the determination device 402 is configured to: determine the type of the first MCS table on the basis of the service-Table carried by the indication information, and the service-Table is the newly defined field used to indicate the type of the MCS table, and the service-Table includes at least one bit; and determine that the first MCS table is the MCS table included in the second type of MCS tables, the under the condition that the first MCS table is determined to be the second type of MCS tables, and the second type of MCS tables only includes one MCS table.

In one embodiment, under the condition that the indication information is the mcs-Table, the determination device 402 is configured to: determine the first MCS table corresponding to the value of the mcs-Table on the basis of the value of the mcs-Table, and the mcs-Table includes at least two bits, the different values of the mcs-Table are used to indicate the different MCS tables, and one value corresponds to one MCS table.

In one embodiment, the first type of MCS tables includes 64 QAM and 256 QAM; and the second type of MCS tables at lease includes the MCS table corresponding to the bler-Target of 10⁻⁵.

The terminal can be configured to execute the method executed by the terminal in the method provided by the embodiment shown in the FIG. 1, and therefore the functions and the like which can be achieved by functional devices of the terminal may refer to description of the embodiment shown in the FIG. 1 and are not repeated herein.

Referring to FIG. 5, based on the same inventive concept, an embodiment of the present disclosure provides a base station, including: a sending device 501, configured to send RRC signaling carrying indication information to a terminal, and thus allowing the terminal to be able to determine a first MCS table on the basis of the indication information, and the indication information is used to indicate the first MCS table, and the first MCS table is one of a first type of MCS tables and a second type of MCS tables.

In one embodiment, the indication information is a cqi-Table, and the different values of the cqi-Table are used to indicate the different MCS tables, and one value corresponds to one MCS table.

In one embodiment, an mcs-Table is carried in the indication information; when the first MCS table is the first type of MCS tables, the value of the mcs-Table is in one-to-one correspondence with each MCS table in the first type of MCS tables; or when the first MCS table is the second type of MCS tables, the value of the mcs-Table is in one-to-one correspondence with each MCS table in the second type of MCS tables.

In one embodiment, the base station also includes a first determination device 502, configured to: determine the type of the first MCS table; and determine that bler-Target does not need to be carried in the indication information, when the first MCS table is determined to be the first type of MCS tables; or determine that the bler-Target needs to be carried in the indication information, when the first MCS table is determined to be the second type of MCS tables.

In one embodiment, when the bler-Target carried by the indication information is a first value, the bler-Target is used to indicate that the first MCS table is the second type of MCS tables; or when the bler-Target carried by the indication information is a second value, the bler-Target is used to indicate that the first MCS table is the second type of MCS tables, and the first value and the second value are used to indicate the different MCS tables included in the second type of MCS tables, respectively; or when the bler-Target carried by the indication information is the second value, the bler-Target is used to indicate that the first MCS table is the first type of MCS tables.

In one embodiment, the base station also includes a second determination device 503, configured to: determine the type of the first MCS table; and determine that a newly defined new-mcs-Table used to indicate the second type of MCS tables needing to be carried in the indication information, when the first MCS table is determined to be the second type of MCS tables, and the value of the new-mcs-Table is in one-to-one correspondence with each MCS table in the second type of MCS tables; or determine that the new-mcs-Table does not need to be carried in the indication information, when the first MCS table is determined to be the first type of MCS tables.

In one embodiment, the indication information includes a service-Table, and the service-Table is the newly defined field used to indicate the type of the MCS table, and the service-Table includes at least one bit; and under the condition that the type indicated by the service-Table is the second type of MCS tables, the indication information carries the new-mcs-Table, and the value of the new-mcs-Table is in one-to-one correspondence with each MCS table in the second type of MCS tables; or under the condition that the type indicated by the service-Table is the first type of MCS tables, the indication information does not carry the new-mcs-Table, and the value of the mcs-Table carried by the indication information is in one-to-one correspondence with each MCS table in the first type of MCS tables.

In one embodiment, the indication information includes the service-Table, the service-Table is the newly defined field used to indicate the type of the MCS table, and the service-Table includes at least one bit; and under the condition that the type indicated by the service-Table is the second type of MCS tables, the value of the mcs-Table carried by the indication information is in one-to-one correspondence with each MCS table in the second type of MCS tables; or under the condition that the type indicated by the service-Table is the first type of MCS tables, the value of the mcs-Table is in one-to-one correspondence with each MCS table in the first type of MCS tables.

In one embodiment, the indication information includes the service-Table, and the service-Table is the newly defined field used to indicate the type of the MCS table, and the service-Table includes at least one bit; and under the condition that the type indicated by the service-Table is the second type of MCS tables, and the second type of MCS tables only includes one MCS table, the first MCS table is the MCS table included in the second type of MCS tables.

In one embodiment, the indication information is the mcs-Table, and the mcs-Table includes at least two bits, the different values of the mcs-Table are used to indicate the different MCS tables, and one value corresponds to one MCS table.

In one embodiment, the first type of MCS tables includes 64 QAM and 256 QAM; and the second type of MCS tables at lease includes the MCS table corresponding to the bler-Target of 10⁻⁵.

The base station can be configured to execute part of the method executed by the base station in the method provided by the embodiment shown in the FIG. 1, and therefore the functions and the like which can be achieved by functional devices of the base station can refer to description of the embodiment shown in the FIG. 1 and are not repeated herein. The first determination device 502 and the second determination device 503 are shown together in FIG. 5, and it needs to be noted that both devices are not necessarily functional devices and are thus shown in dashed lines in FIG. 5.

Based on the same inventive concept, an embodiment of the present disclosure provides a readable storage medium in which a computer command is stored, and when the computer command is run on a computer, the computer executes the method as shown in FIG. 1.

In a specific implementation process, the computer readable storage medium includes various storage mediums for storing program codes, such as a universal serial bus flash drive (USB), a mobile hard disk, a read-only memory (ROM), a random access memory (RAM), a magnetic disk or an optical disk.

In the embodiments of the present disclosure, it should be understood that the disclosed equipment and methods can be implemented in other ways. For example, the equipment embodiments described above are merely illustrative, e.g., division of devices is merely division of logical functions, and there may be other division ways in actual implementation, e.g., the plurality of devices or components can be combined or integrated into another system, or some features can be omitted, or not performed. As another point, shown or discussed coupling or direct coupling or communication connection to each other may be achieved through some interfaces, indirect coupling or communication connection between equipment or the devices may be in electrical or other forms.

Functional devices in the embodiments of the present disclosure may be integrated in a processing device, or each device may also be an independent physical device.

When being implemented in the form of a software functional device and sold or used as an independent product, the integrated device can be stored in the computer readable storage medium. Based on such understanding, all or part of the embodiments of the present disclosure can be embodied in the form of a software product that is stored in a storage medium and includes a plurality of commands for enabling computer equipment, such as a personal computer, a server, or network equipment, or a processor to carry out all or part of the steps of the methods described in the various embodiments of the present disclosure. The storage medium mentioned above includes various mediums for storing program codes, such as a universal serial bus flash drive, a mobile hard disk, a read only memory (ROM), a random access memory (RAM), a magnetic disk or an optical disk.

1. A method for determining a modulation and coding scheme (MCS) table, comprising
receiving, by a terminal, radio resource control (RRC) signaling carrying indication information and sent by a base station, wherein the indication information indicates a first MCS table, and the first MCS table is one of a first type of MCS tables and a second type of MCS tables; and
determining, by the terminal, the first MCS table based on the indication information.

2. The method according to claim 1, wherein the determining, by the terminal, the first MCS table based on the indication information by one of following schemes:
scheme 1: when the indication information is a channel quality indicator table (cqi-Table), determining, by the terminal, the first MCS table corresponding to a value of the cqi-Table based on the value of the cqi-Table, wherein different values of the cqi-Table indicate different MCS tables, and one value corresponds to one MCS table
scheme 2: determining, by the terminal, a type of the first MCS table based on the indication information; when the first MCS table is determined to be the first type of MCS tables, determining, by the terminal, the first MCS table from the first type of MCS tables based on an mcs-Table carried by the indication information, wherein a value of the mcs-Table is in one-to-one correspondence with each MCS table in the first type of MCS tables; or when the first MCS table is determined to be the second type of MCS tables, determining, by the terminal, the first MCS table from the second type of MCS tables based on an mcs-Table carried by the indication information, wherein a value of the mcs-Table is in one-to-one correspondence with each MCS table in the second type of MCS tables;
scheme 3: when the terminal determines that the indication information carries a newly defined new-mcs-Table configured to indicate the second type of MCS tables, determining, by the terminal, the first MCS table from the second type of MCS tables based on a value of the new-mcs-Table, wherein the value of the new-mcs-Table is in one-to-one correspondence with each MCS table in the second type of MCS tables; or when the terminal determines that the indication information does not carry a new-mcs-Table, determining, by the terminal, the first MCS table from the first type of MCS tables based on the value of the mcs-Table carried by the indication information, wherein the value of the mcs-Table is in one-to-one correspondence with each MCS table in the first type of MCS tables;
scheme 4: determining, by the terminal, a type of the first MCS table based on a service-Table carried by the indication information, wherein the service-Table is a newly defined field configured to indicate a type of an MCS table, and the service-Table comprises at least one bit and when the terminal determines that the first MCS table is the second type of MCS tables, determining, by the terminal, the first MCS table from the second type of MCS tables based on a value of a new-mcs-Table carried by the indication information, wherein the value of the new-mcs-Table is in one-to-one correspondence with each MCS table in the second type of MCS tables; or when the terminal determines that the first MCS table is the first type of MCS tables, determining, by the terminal, the first MCS table from the first type of MCS tables based on a value of an mcs-Table carried by the indication information, wherein the value of the mcs-Table is in one-to-one correspondence with each MCS table in the first type of MCS tables;
scheme 5: determining, by the terminal, a type of the first MCS table based on a service-Table carried by the indication information, wherein the service-Table is a newly defined field configured to indicate a type of an MCS table, and the service-Table comprises at least one bit and when the terminal determines that the first MCS table is the second type of MCS tables, determining, by the terminal, the first MCS table from the second type of MCS tables based on a value of an mcs-Table carried by the indication information, wherein the value of the mcs-Table is in one-to-one correspondence with each MCS table in the second type of MCS tables; or when the terminal determines that the first MCS table is the first type of MCS tables, determining, by the terminal, the first MCS table from the first type of MCS tables based on a value of an mcs-Table carried by the indication information, wherein the value of the mcs-Table is in one-to-one correspondence with each MCS table in the first type of MCS tables;
scheme 6: determining, by the terminal, a type of the first MCS table based on a service-Table carried by the indication information, wherein the service-Table is a newly defined field configured to indicate a type of an MCS table, and the service-Table comprises at least one bit and when the terminal determines that the first MCS table is the second type of MCS tables and the second type of MCS tables only comprise one MCS table, determining, by the terminal, that the first MCS table is an MCS table comprised in the second type of MCS tables;
scheme 7: determining, by the terminal, the first MCS table corresponding to a value of the mcs-Table based on the value of the mcs-Table, wherein the mcs-Table comprises at least two bits, different values of the mcs-Table are configured to indicate different MCS tables, and one value corresponds to one MCS table.

3. (canceled)

4. The method according to claim 2, wherein the
determining, by the terminal, the type of the first MCS table based on the indication information comprises:
determining, by the terminal, whether the indication information carries a target block error rate (bler-Target); and
determining, by the terminal, the first MCS table to be the first type of MCS tables in response to that the indication information does not carry the bler-Target; or determining, by the terminal, the first MCS table to be the second type of MCS tables in response to that the indication information carries the bler-Target.

5. The method according to claim 2, wherein the determining, by the terminal, the type of the first MCS table based on the indication information comprises:
when the terminal determines that a bler-Target carried by the indication information is a first value, determining that the first MCS table is the second type of MCS tables; or
when the terminal determines that the bier-Target carried by the indication information is a second value, determining the type of the first MCS table based on the value of the cqi-Table carried by the indication information.

6-10. (canceled)

11. The method according to claim 1, wherein the first type of MCS tables comprise 64 QAM and 256 QAM; and the second type of MCS tables comprise at lease an MCS table corresponding to a bier-Target of 10⁻⁵.

12. A method for determining an MCS table, comprising:
sending, by a base station, RRC signaling carrying indication information to a terminal, to enable the terminal to determine a first MCS table based on the indication information, wherein the indication information indicates the first MCS table, and the first MCS table is one of a first type of MCS tables and a second type of MCS tables.

13. The method according to claim 12, wherein the indication information is a cqi-Table, wherein different values of the cqi-Table indicate different MCS tables, and one value corresponds to one MCS table^{.} or
wherein the indication information carries an mcs-Table; when the first MCS table is the first type of MCS tables, an value of the mcs-Table is in one-to-one correspondence with each MCS table in the first type of MCS tables; or when the first MCS table is the second type of MCS tables, an value of the mcs-Table is in one-to-one correspondence with each MCS table in the second type of MCS tables; or
wherein the indication information comprises a service-Table, wherein the service-Table is a newly defined field configured to indicate a type of an MCS table, and the service-Table comprises at least one bit and when the type indicated by the service-Table is the second type, a new-mcs-Table is carried in the indication information, and a value of the new-mcs-Table is in one-to-one correspondence with each MCS table in the second type of MCS tables; or when the type indicated by the service-Table is the first type, a new-mcs-Table is not carried in the indication information, and a value of an mcs-Table carried by the indication information is in one-to-one correspondence with each MCS table in the first type of MCS tables; or
wherein the indication information comprises a service-Table, the service-Table is a newly defined field configured to indicate a type of an MCS table, and the service-Table comprises at least one bit and when the type indicated by the service-Table is the second type, the value of the mcs-Table carried by the indication information is in one-to-one correspondence with each MCS table in the second type of MCS tables; or when the type indicated by the service-Table is the first type, the value of the mcs-Table is in one-to-one correspondence with each MCS table in the first type of MCS tables; or
wherein the indication information comprises a service-Table, the service-Table is a newly defined field configured to indicate a type of an MCS table, and the service-Table comprises at least one bit and when the type indicated by the service-Table is the second type, and the second type of MCS tables only comprise one MCS table, the first MCS table is an MCS table comprised in the second type of MCS tables; or
wherein the indication information is an mcs-Table, the mcs-Table comprises at least two bits, different values of the mcs-Table are configured to indicate different MCS tables, and one value corresponds to one MCS table.

14. (canceled)

15. The method according to claim 13, wherein before the base station sends the RRC signaling carrying the indication information to the terminal, the method further comprises:
determining, by the base station, a type of the first MCS table; and
when the base station determines that the first MCS table is the first type of MCS tables, determining, by the base station, that a bler-Target does not need to be carried in the indication information; or
when the base station determines that the first MCS table is the second type of MCS tables, determining, by the base station, that a bler-Target needs to be carried in the indication information.

16. The method according to claim 13, wherein when a bler-Target carried by the indication information is a first value, the bler-Target is configured to indicate that the first MCS table is the second type of MCS tables; or
when a bler-Target carried by the indication information is a second value, the bler-Target is configured to indicate that the first MCS table is the second type of MCS tables, wherein the first value and the second value are configured to indicate different MCS tables comprised in the second type of MCS tables, respectively; or
when a bler-Target carried by the indication information is the second value, the bler-Target is configured to indicate that the first MCS table is the first type of MCS tables.

17. The method according to claim 12, wherein before the base station sends the RRC signaling carrying the indication information to the terminal, the method further comprises:
determining, by the base station, a type of the first MCS table; and
when the base station determines that the first MCS table is the second type of MCS tables, determining, by the base station, that a newly defined new-mcs-Table configured to indicate the second type of MCS tables needs to be carried in the indication information, wherein a value of the new-mcs-Table is in one-to-one correspondence with each MCS table in the second type of MCS tables; or
when the base station determines that the first MCS table is the first type of MCS tables, determining, by the base station, that a new-mcs-Table does not need to be carried in the indication information.

18-21. (canceled)

22. The method according to claim 12, wherein the first type of MCS tables comprise 64 QAM and 256 QAM; and the second type of MCS tables comprise at lease an MCS table corresponding to a bler-Target of 10⁻⁵.

23. A terminal, comprising:
a memory, configured to store instructions;
a processor, configured to read the instructions in the memory to execute following processes:
receiving RRC signaling carrying indication information and sent by a base station through a transceiver, wherein the indication information indicates a first MCS table, and the first MCS table is one of a first type of MCS tables and a second type of MCS tables; and
determining the first MCS table based on the indication information; and
the transceiver, configured to receive and send data under the control of the processor.

24. The terminal according to claim 23, wherein the processor is further configured to:
when the indication information is a cqi-Table, determine the first MCS table corresponding to a value of the cqi-Table based on the value of the cqi-Table, wherein different values of the cqi-Table indicate different MCS tables, and one value corresponds to one MCS table
determine a type of the first MCS table based on the indication information; and
when the first MCS table is determined to be the first type of MCS tables, determine the first MCS table from the first type of MCS tables based on an mcs-Table carried by the indication information, wherein a value of the mcs-Table is in one-to-one correspondence with each MCS table in the first type of MCS tables; or when the first MCS table is determined to be the second type of MCS tables, determine the first MCS table from the second type of MCS tables based on an mcs-Table carried by the indication information, wherein a value of the mcs-Table is in one-to-one correspondence with each MCS table in the second type of MCS tables;
when it is determined that the indication information carries a newly defined new-mcs-Table configured to indicate the second type of MCS tables, determine the first MCS table from the second type of MCS tables based on the value of the new-mcs-Table, wherein the value of the new-mcs-Table is in one-to-one correspondence with each MCS table in the second type of MCS tables; or when it is determined that the indication information does not carry a new-mcs-Table, determine the first MCS table from the first type of MCS tables based on the value of the mcs-Table carried by the indication information, wherein the value of the mcs-Table is in one-to-one correspondence with each MCS table in the first type of MCS tables;
determine a type of the first MCS table based on a service-Table carried by the indication information, wherein the service-Table is a newly defined field configured to indicate a type of an MCS table, and the service-Table comprises at least one bit and when the first MCS table is determined to be the second type of MCS tables, determine the first MCS table from the second type of MCS tables based on a value of a new-mcs-Table carried by the indication information, wherein the value of the new-mcs-Table is in one-to-one correspondence with each MCS table in the second type of MCS tables; or when the first MCS table is determined to be the first type of MCS tables, determine the first MCS table from the first type of MCS tables based on a value of an mcs-Table carried by the indication information, wherein the value of the mcs-Table is in one-to-one correspondence with each MCS table in the first type of MCS tables;
determine a type of the first MCS table based on a service-Table carried by the indication information, wherein the service-Table is a newly defined field configured to indicate a type of an MCS table, and the service-Table comprises at least one bit and when the first MCS table is determined to be the second type of MCS tables, determine the first MCS table from the second type of MCS tables based on a value of an mcs-Table carried by the indication information, wherein the value of the mcs-Table is in one-to-one correspondence with each MCS table in the second type of MCS tables; or when the first MCS table is determined to be the first type of MCS tables, determine the first MCS table from the first type of MCS tables based on a value of an mcs-Table carried by the indication information, wherein the value of the mcs-Table is in one-to-one correspondence with each MCS table in the first type of MCS tables;
determine a type of the first MCS table based on a service-Table carried by the indication information, wherein the service-Table is a newly defined field configured to indicate a type of an MCS table, and the service-Table comprises at least one bit and when the first MCS table is the second type of MCS tables and the second type of MCS tables only comprise one MCS table, determine that the first MCS table is an MCS table comprised in the second type of MCS tables; or
when the indication information is an mcs-Table, determine the first MCS table corresponding to a value of the mcs-Table based on the value of the mcs-Table, wherein the mcs-Table comprises at least two bits, different values of the mcs-Table are configured to indicate different MCS tables, and one value corresponds to one MCS table.

25. (canceled)

26. The terminal according to claim 24, wherein the processor is further configured to:
determine whether the indication information carries a bler-Target; and
determine the first MCS table to be the first type of MCS tables, in response to that the indication information does not carry the bler-Target; or determine the first MCS table to be the second type of MCS tables in response to that the indication information carries the bler-Target; or
wherein the processor is further configured to: when the bler-Target carried by the indication information is determined to be a first value, determine the first MCS table to be the second type of MCS tables; or when the bler-Target carried by the indication information is determined to be a second value, determine the type of the first MCS table based on the value of the cqi-Table carried by the indication information.

27-32. (canceled)

33. The terminal according to claim 23, wherein the first type of MCS tables comprise 64 QAM and 256 QAM; and the second type of MCS tables comprise at lease an MCS table corresponding to a bler-Target of 10⁻⁵.

34. A base station, comprising:
a memory, configured to store instructions;
a processor, configured to read the instructions in the memory to execute the method according to claim 12; and
a transceiver, configured to receive and send data under the control of the processor.

35. The base station according to claim 34, wherein the indication information is a cqi-Table, wherein different values of the cqi-Table indicate different MCS tables, and one value corresponds to one MCS table; or
wherein the indication information carries an mcs-Table; when the first MCS table is the first type of MCS tables, an value of the mcs-Table is in one-to-one correspondence with each MCS table in the first type of MCS tables; or when the first MCS table is the second type of MCS tables, an value of the mcs-Table is in one-to-one correspondence with each MCS table in the second type of MCS tables; or
wherein the indication information comprises a service-Table, the service-Table is a newly defined field configured to indicate a type of an MCS table, and the service-Table comprises at least one bit and when the type indicated by the service-Table is the second type, a new-mcs-Table is carried in the indication information, and a value of the new-mcs-Table is in one-to-one correspondence with each MCS table in the second type of MCS tables; or when the type indicated by the service-Table is the first type, a new-mes-Table is not carried in the indication information, and a value of an mcs-Table carried by the indication information is in one-to-one correspondence with each MCS table in the first type of MCS tables; or
wherein the indication information comprises a service-Table, the service-Table is the newly defined field configured to indicate a type of an MCS table, and the service-Table comprises at least one bit and when the type indicated by the service-Table is the second type, the value of the mcs-Table carried by the indication information is in one-to-one correspondence with each MCS table in the second type of MCS tables; or when the type indicated by the service-Table is the first type, the value of the mcs-Table is in one-to-one correspondence with each MCS table in the first type of MCS tables; or
wherein the indication information comprises a service-Table, the service-Table is a newly defined field configured to indicate a type of an MCS table, and the service-Table comprises at least one bit and when the type indicated by the service-Table is the second type, and the second type of MCS tables only comprise one MCS table, the first MCS table is an MCS table comprised in the second type of MCS tables; or
wherein the indication information is an mcs-Table, the mcs-Table comprises at least two bits, different values of the mcs-Table are configured to indicate different MCS tables, and one value corresponds to one MCS table.

36. (canceled)

37. The base station according to claim 35, wherein the processor is further configured to:
determine a type of the first MCS table; and
when the first MCS table is determined to be the first type of MCS tables, determine that a bler-Target does not need to be carried in the indication information; or
when the first MCS table is determined to be the second type of MCS tables, determine that a bler-Target needs to be carried in the indication information^{.} or
wherein when a bler-Target carried by the indication information is a first value, the bler-Target is configured to indicate that the first MCS table is the second type of MCS tables; or when a bler-Target carried by the indication information is a second value, the bler-Target is configured to indicate that the first MCS table is the second type of MCS tables, wherein the first value and the second value are configured to indicate different MCS tables comprised in the second type of MCS tables, respectively; or when a bler-Target carried by the indication information is the second value, the bler-Target is configured to indicate that the first MCS table is the first type of MCS tables.

38. (canceled)

39. The base station according to claim 34, wherein the processor is further configured to:
determine a type of the first MCS table; and
when the first MCS table is determined to be the second type of MCS tables, determine that a newly defined new-mcs-Table configured to indicate the second type of MCS tables needs to be carried in the indication information, wherein a value of the new-mcs-Table is in one-to-one correspondence with each MCS table in the second type of MCS tables; or
when the first MCS table is determined to be the first type of MCS tables, determine that a new-mcs-Table does not need to be carried in the indication information.

40-43. (canceled)

44. The base station according to claim 34, wherein the first type of MCS tables comprise 64 QAM and 256 QAM; and the second type of MCS tables comprises at lease an MCS table corresponding to a bler-Target of 10⁻⁵.

45-47. (canceled)
